(19) United States
(12) Patent Application Publication
(10) Pub. No.: US 2009/0266276 A1
(43) Pub. Date: Oct. 29, 2009

(54) Method for producing transport pallets from plastic

(76) Inventor: ACHIM KOENES, Wuppertal (DE)

Correspondence Address: HENRY M FEIEREISEN, LLC;HENRY M FEIEREISEN, 708 THIRD AVENUE, SUITE 1501, NEW YORK, NY, 10017, US

(21) Appl. No.: 12/259,719

(22) Filed: Oct. 28, 2008

(30) Foreign Application Priority Data
Oct. 29, 2007 (DE) 10 2007 051 939.9

(51) Int. Cl. C08J 9/00; B65D 19/38; B65D 19/24

(52) U.S. Cl. 108/57.28; 264/41

(57) ABSTRACT

The invention relates to a method for producing transport pallets from a mixture of recycled plastics with optional addition of fibrous material, wherein the mixture is portioned in an extruder (1), liquefied into a paste by heating and introduced via the conveying screw of the extruder into a closed mold (9) for hardening. The liquefied mixture from the extruder is intermediately stored in a storage device (4) having an adjustable volume, while the mold is changed.

The invention relates to a method for producing transport pallets according to the preamble of claim 1. A method and corresponding transport pallets of this type are known from EP 1 606 178 B1 and from WO 2005/068309, which is pending in the United States Patent Office with the application Ser. No. 10/597,210, the content of which is hereby incorporated by reference.

The conventional method for producing transport pallets from plastic uses recycled plastics with optional addition of organic fibers, preferably cellulose fibers and alternatively or in addition hemp fibers. This produces a type of micro-armor of the plastic, whereby the tensile strength and flexural strength and hence the firmness of the material are significantly improved. Recycled plastics include, for example, mixtures of polyethylene and/or polypropylene and/or polycarbonates, with a content of foreign matter of not more than 10% (volume fraction). Such plastics are available in large quantities in Germany due to the so-called packaging material recycling effort. The employed cellulose fibers have preferably a mean fiber length in the range of 0.5 to 3 mm, preferably 1 to 2 mm, and particularly preferred of about 1.4 mm. The mean diameter is in the range of 10 to 100 μm, preferably about 60 μm. This results in a typical fiber tensile strength of at least about 1 N/mm². The volume fraction of fibers is between 5% and 50%, preferably between 10% and 20%, particularly preferred of about 15% (i.e., 15% fibers and 85% plastic mixture). The precisely employed fraction depends on the quality of the recycled plastic mixture and the requirements for the ultimate loads to which the pallet is subjected. As a trend, the firmness of the plastic increases with increasing fiber fraction.

The problems associated with processing of the mixture of recycled plastics and the fibrous material become more severe with increasing fiber fraction and fiber length, respectively. Typical injection molding processes cannot be used, because the fine nozzles of injection molding machines can easily be obstructed by the inhomogeneous material, and large single-piece objects like transport pallets can also not be produced economically by injection molding. Instead, a casting technique is used wherein the material mixture is transformed into a paste with an extruder and pressed into aluminum molds. After the molds are completely filled, which takes place using several fill openings depending on the mold, the molds are undocked from the extruder so that the plastic can cool down for a certain time of, for example, half an hour, instead of immediately ejecting the molded workpiece, as is the case with injection molding processes.

Disadvantageously, however, when employing the conventional method for producing transport pallets disclosed in EP 1 606 178 B1, the extruder must be stopped for changing the molds and/or for docking another fill opening. This results in a longer residence time for the paste-like plastic in the heated sections of the device and can cause discoloration of the plastic, in particular when producing relatively light-colored pallets Moreover, because the composition of recycled materials can vary, causing changes in the properties of the material, the adverse effects are exacerbated in different ways during a longer residence time in the extruded device. Because the plastic does not flow during the mold change, the overall efficiency of the entire facility is reduced.

It is therefore an object of the present invention to ensure a continuous operation of the extruder even when a mold change is required.

The object is solved in a method of the aforedescribed type by the characterizing features of claim 1.

Advantageous embodiments of the invention are recited in the dependent claims.

In the method of the invention, storage devices with changeable volume are used which operate similar to the so-called “accumulator heads” or “storage heads” which are known, for example, from DE 692 18 610 T2 for extrusion blow-molding.

To prevent non-uniform residence times of the plastic in the accumulator head, it is also known to provide accumulator heads with so-called FIFO (first in-first out). The material first introduced into the accumulator head is also first discharged during withdrawal by using a ring piston.

In extrusion blow-molding, the accumulator head is used to intermediately store the plastic during the time when no mold is docked. However, the accumulator head-extrusion blow-forming process uses high pressures of a similar magnitude as injection molding, where pressures typically reach 1000 bar, and the filling times of the mold are also relatively short, because the pre-form must be hot during blow-molding.

Occasionally, accumulator heads are also used in injection molding where they serve as a sort of safety container which receives plastic that cannot be transported from the extruder to the mold at that particular time. In addition, the injected quantity of a plastic during injection molding is determined not only by the injection time, but basically also by the volume of the mold.

Conversely, in the present invention, the plastic is initially always transported into the storage device. This has the following advantage: the flow through the extruder can conventionally not be precisely determined, so that it has so far not been possible to exactly determine during the production of plastic pallets the volume of the plastic already supplied to the molds. The casting process was until now considered finished when plastic poured out of all openings of the molds, based on visual inspection. However, with the storage device of the invention, the plastic can be precisely metered, for example, in a storage device with a cylinder and a piston by controlling the advance of the piston in the cylinder, allowing the molds to be filled more precisely and, more importantly, automatically. This is done by initially introducing the desired volume into the storage device, which is then transported into the mold, i.e., the storage device is sized to contain the entire mold volume of a mold of, for example, 20 liter.

With the invention, the requirements for pressure generating efficiency and transport efficiency of extruder and accumulator head and the compressive strength of the mold are much lower than with injection molding and also significantly lower than with extrusion blow-molding, which substantially reduces the required size of the extruder, accumulator head and molds used in the production of transport pallets.

It is also contemplated within the context of the present invention to add a blowing agent during or after the liquefied mixture is transported from the extruder into the storage device, which produces a gas distributed in small bubbles at the temperature of the liquefied mixture during its residence time in the storage device and creates a foam structure in the transport pallet. This produces a structure with certain pores or in form of a high-resistance (HR) foam, which due to the reduction in density for a predetermined volume significantly reduces the material required for the pallets and hence also the tare weight of the pallets. This reduction in density is preferred over a reduction in volume of the pallet, because the geometry of the pallet is determined by certain boundary conditions (supportability by forklift trucks, etc.).

Depending on the employed quantity and the type of the blowing agent, weight reductions of about 5% to about 50% can advantageously be attained. It has been observed that the strength requirements of the pallets can be easily met even with such expanded plastic mixture. The desired weight reduction can be achieved by adding different amounts of a blowing agent and by metering the plastic accordingly, without the need to reconfigure the facility. Pallets of different weight classes and load-bearing capacity can then be produced in one facility without additional set-up times.

In the context of the present invention, the combination of an accumulator head, in which the blowing agent can be operative with a defined residence time and under a defined pressure that allows sufficient bubble expansion, with a relatively low-pressure and slow supply of the foamed plastic into the mold has proven to be advantageous. Even less effective blowing agents can then optimally expand, and the plastic has also sufficient time to close the surface pores before final solidification, producing sufficiently smooth, compact outer skins which also meet sanitary considerations.

The blowing agents can be chemical or physical blowing agents. The blowing agents can furthermore be applied in different forms and physical states, e.g., as liquids, gels, powders or master batches, wherein the blowing agent is applied onto pellets.

One chemical blowing agent, which can also be used in the food industry, is for example sodium bicarbonate in conjunction with citric acid or its derivates. Disadvantageously, the expansion effect of blowing agent based on citric acid is often too small to allow normal processing with extruders, unlike other known blowing agents which release ammonia and can therefore only be applied in the food industry within limits. However, in the context of this invention, the blowing agent can controllably expand in the accumulator head under specifically adapted pressure conditions and for predetermined times, so that even blowing agents with smaller efficiency and/or pressure generation capability can be employed.

The blowing agents are preferably added to the plastic when the plastic is transported from the extruder into the storage device, because a defined time is then available to the blowing agent for expansion at a defined and relatively low pressure. Alternatively, the blowing agent can also be added later, in particular when the plastic is supplied to the mold. Adding the blowing agent already in the extruder is less advantageous, although this is possible in principle with relatively stable blowing agents.

Although preferably plastics foamed with blowing agents are used in the context of the invention, according to another aspect of the present invention, because of the presence of the storage device a continuous filling process can be attained with non-foamed plastics at low pressures of 50 bar, preferably less than 30 bar.

An exemplary embodiment of the invention will now be described with reference to the drawings.

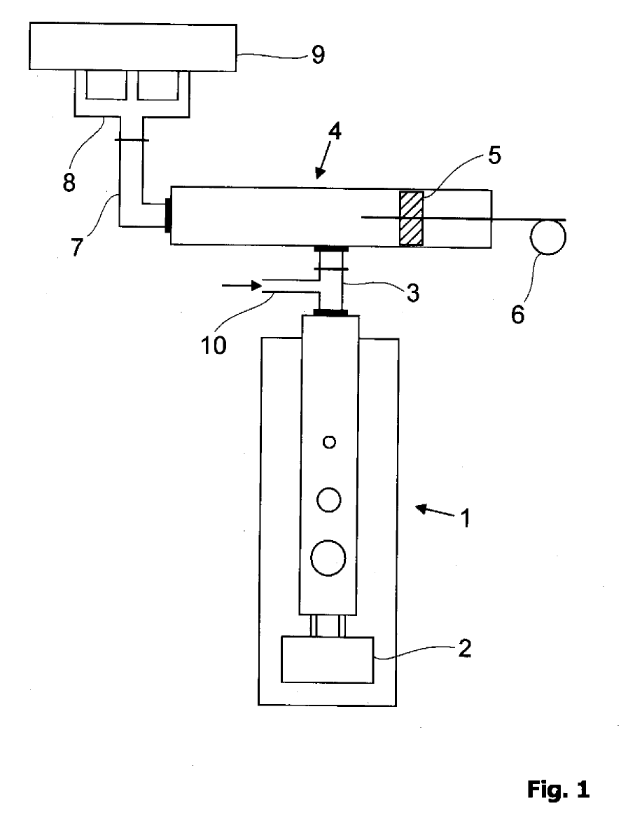

FIG. 1 shows a schematic diagram of a first embodiment of a facility for producing transport pallets made of plastic; and

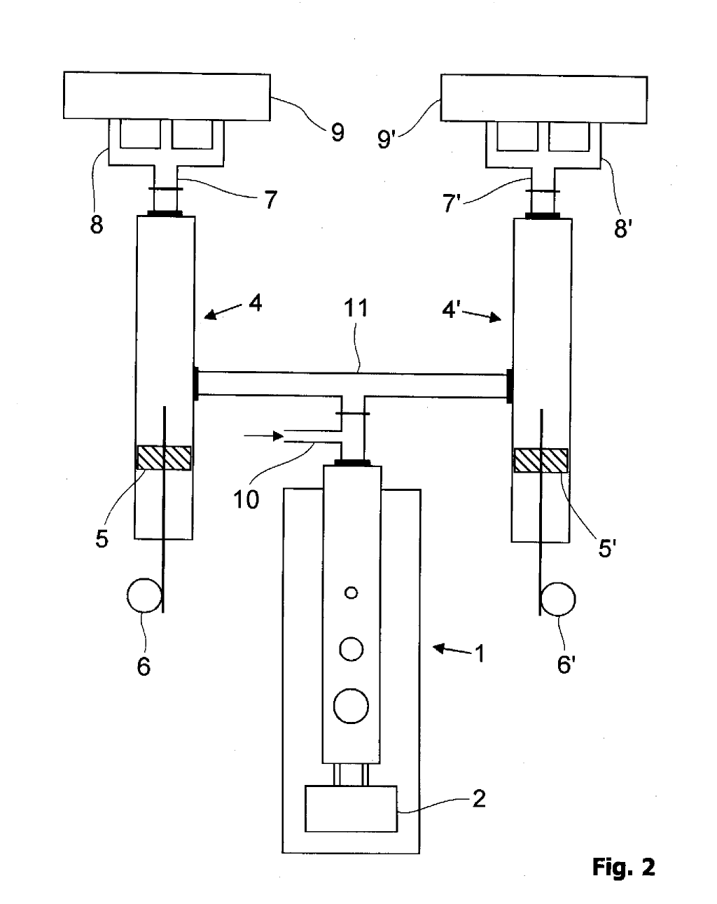

FIG. 2 shows a schematic diagram of a second embodiment of a facility for producing transport pallets made of plastic.

The facility shown in FIG. 1 includes an extruder 1 which is driven by an electric motor 2. The extruder 1 refers only to a device that liquefies and supplies a plastic. No additional devices for generating a particularly high pressure, as required for injection molding, are here necessary.

The outlet of the extruder 1 is connected via a conduit 3 with an inlet of a storage device 4 having an adjustable volume, hereinafter referred to as cartridge and schematically illustrated as a cylinder in which a piston 5 can be moved back and forth with a spindle and an electric motor 6 for changing the volume of the cartridge 4. The cartridge 4 performs a FIFO function.

The outlet of the cartridge 4 is connected via a conduit 7 and a distributor 8 with an aluminum mold 9 for plastic pallets.

Valves which are indicated in the conduits by transverse lines are disposed in the conduits 3 and 7. Conduit 3 also includes a branch connection 10 whose function will be described later.

The device illustrated in FIG. 1 operates as follows:

A mixture of recycled plastics and fibers material is portioned in the extruder 1, liquefied into a paste by heating and transported by the conveying screw of the extruder 1 into the cartridge 4. During this process, where the valve in a conduit 3 is open and the valve in the conduit 7 is closed, an empty aluminum mold 9 is connected to the distributor 8. The valve in conduit 7 is then opened and the material accumulated in the cartridge 4 is pressed at a pressure of less than 50 bar, preferably less than 30 bar, relatively slowly, i.e., over a time of several minutes, from the cartridge 4 into the aluminum mold 9. When being full, the aluminum mold 9 is decoupled from the distributor 8, while the valve in conduit 7 is closed, and cooled with water for hardening, while the cartridge 4 is again filled via conduit 3 from the extruder 1. During this time, an empty aluminum mold 9 is connected to the distributor 8, etc.

In a variant of this method, a certain quantity of a blowing agent is added to the mixture between the extruder 1 and the cartridge 4, wherein the mixture is capable of producing a gas at certain temperatures (e.g., at about 180° C.). The blowing agent is fed in the direction indicated by the arrow via the branch connection 10 and distributed in the mixture by nozzles (not shown). While the mixture resides in the cartridge 4 for a defined time, the blowing agent releases a defined amount of gas, so that the mixture, which is subsequently transported into the mold 9 where it hardens, also contains a defined quantity of gas in form of small bubbles, in addition to the recycled plastic. In this variant, the quantity of plastic supplied to the cartridge 4 has to be decreased accordingly. In this embodiment, where a blowing agent is added, there may no longer be a need to add fibrous material.

A foam structure is thereby produced in the completed transport pallet which can hence be significantly lighter while having an almost identical rigidity, and which can be produced with significantly less material than a solid transport pallet.

It should be noted that addition of the blowing agent in the extruded 1 is not recommended, because the bubble formation in the mixture would not be reproducible due to variable pressures and unspecified residence times in the extruder 1.

The facility illustrated in FIG. 2 allows two molds 9 to be filled continuously and simultaneously. The devices of the facility illustrated in FIG. 1 are implemented twice—with the exception of the extruder 1 which preferably has approximately twice the output of the extruder of FIG. 1 and also with the exception of the electric motor 2 associated with the extruder—, wherein identical elements or elements performing a substantially identical function have the same reference symbols as in FIG. 1, albeit appended with an apostrophe in the second version. The conduit corresponding to conduit 3 in FIG. 1 is implemented in FIG. 2 as a distributor 11 extending from the extruder to the two cartridges 4 and 4′.

The device shown in FIG. 2 operates basically in the same way as the device of FIG. 1; however, the two molds 9, 9′ are alternatingly docked and filled, wherein the cartridges 4 and 4′ are supplied with the mixture from a common extruder 1. Initially, the required quantity of plastic is transported into the cartridge 4, and as soon as the cartridge reaches a predetermined quantity of plastic, the extruder is connected with the other cartridge 4′. While the other cartridge 4′ is filled, the content of the first cartridge 4 is ejected into the mold 9. This ejection process, including the subsequent mold change, is terminated before the other cartridge 4′ is filled up.

1. Method for producing transport pallets from a mixture of recycled plastics, wherein the mixture is portioned in an extruder (1), liquefied into a paste by heating and introduced via the conveying screw of the extruder into a closed mold (9) to harden,
characterized in that
while an empty mold is connected to a storage device (4) with a changeable volume, the liquefied mixture is transported from the extruder into the storage device until a defined quantity of the mixture corresponding to the volume of the mold has accumulated in the storage device, and that after the mold is connected, the quantity of the mixture accumulated in the storage device is pressed from the storage device into the mold in a single operation, and that a blowing agent is added to the mixture during or after the liquefied mixture is transported from the extruder (1) into the storage device (4).

2. Method according to claim 1,
characterized in that
the quantity of the mixture accumulated in the storage device is pressed from the storage device into the mold with a pressure of less than 50 bar, preferably less than 30 bar.

3. Method according to claim 1,
characterized in that
the quantity of the material is pressed into the mold (9) over a time of more than one minute and preferably less than two minutes.

4. Method according to claim 1,
characterized in that
the storage device (4) stores the quantity of material in such a way that the material that is received first from the storage device is also pressed out first.

5. Method according to claim 3,
characterized in that
the quantity of material is pressed into a closed mold (9) implemented as an aluminum mold, and the mold which is disconnected from the storage device (4) is cooled with water for the purpose of hardening.

6. Method according to claim 1,
characterized in that
first and second storage devices (4, 4′) are provided for alternatingly docking and filling two molds, wherein the storage devices are supplied alternatingly with the mixture from a common extruder (1).

7. Method according to claim 1,
characterized in that
fibrous material from recycled plastics is added to the mixture.

8. Method according to claim 7,
characterized in that
the fibrous material consists essentially of cellulose and/or hemp fibers, wherein
the mean fiber length in the fibers material is preferably at least 0.5 mm.

9. Method according to claim 7,
characterized in that
the volume fraction of the fibrous material in the mixture is at least 10%.

10. Method according to claim 1,
characterized in that
addition of the blowing agent results in a weight reduction of the finished transport pallets between about 5% and about 50%.

11. Transport pallet, comprised of a mixture of recycled plastics by optimal addition of fibers material,
characterized in that
the transport pallet is produced by a method according to claim 1.
